(19) United States
(12) Patent Application Publication
(10) Pub. No.: US 2005/0089641 A1
(43) Pub. Date: Apr. 28, 2005

(54) Method and apparatus for making a multilayer coating

(76) Inventors: Stefan Fors, Kausala (FI); Johan Gron, Espoo (FI); Pentti Rautiainen, Jarvenpaa (FI); Timo Eskola, Jarvenpaa (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/497,831

(22) PCT Filed: Dec. 4, 2002
(86) PCT No.: PCT/FI02/00981

(30) Foreign Application Priority Data
Dec. 10, 2001 (FR) 20012427

(51) Int. Cl. B05D 3/02

(52) U.S. Cl. 427/365; 427/391; 427/395; 427/180; 427/209; 427/361

(57) ABSTRACT

A method and assemby is disclosed for manufacturing a two-layer coated paper web, the method comprising the steps of applying a coating furnish layer to at least one surface of said paper web, drying the applied coating furnish layer to a point allowing a next coating layer to be applied thereon. Onto the first coating layer is applied a second coating layer that is dried. The application of successive coating layers is continued until the desired coat thickness is attained. The coating layers are applied using a metering film transfer method operating without leveling of the applied coating layer by doctoring, whereby in at least one of said coating layers is used a furnish having a solids content of not less than 62%.

The present invention relates to a method according to the preamble of claim 1 for applying a multilayer coating to the surface of paper.

The term fine papers is used when reference is made to products in which the base web is made from chemical pulp only or contains not more than 30% of mechanical pulp. To improve its printability qualities, the surface of the paper web is treated in different manners. The most important surface treatment processes are calendering and coating. The smoothest surface that generally also renders the best printing result, is obtained by making at least the topmost coating layer by a blade coater. In blade coating, the coating mix layer applied to the surface of the paper web is smoothed by scraping with a doctor blade. In the manufacture of fine paper grades, multilayer coats are applied and blade coating methods used, wherein coating is applied using an applicator roll, a short-dwell applicator or a nozzle applicator. The coating is applied as an aqueous furnish to both sides of the web in multiple steps. Each applied layer must be dried prior to the application of the next layer. When plural coating layers are to be placed to the web surface and each one of the layers is applied separately, the number of drying steps is multiplied such that three-layer application, for instance, needs six drying cycles. Due to the multiple coating and drying steps, the coater section of a papermaking-machine becomes long and expensive. In addition to the high investment costs of the machine, the drying of coating is an energy-hungry operation that substantially increases the manufacturing cost of paper.

In the manufacture of fine paper grades, blade coating-has traditionally been considered the only feasible way of making at least the top layer of coating for a satisfactorily high-quality printing paper. However, blade coating imposes heavy stresses on the web, whereby the manufacturing process is subject to interruptions. In addition to web breaks, blade coating may cause defects that impair the quality of the manufactured paper. Particularly in the use of on-line calenders, especially multinip calenders, defects in coating may cause damage to the calender rolls. The coat layer may be impaired by broad stripes or narrow lines that generally have a greater amount of coating, rarely with less, than the adjacent areas. The paper may also develop coat windows when holes in the base web are filled with the coating. All these defects cause problems in calendering. If the drying of the coating remains only partial, the web clings readily to the calender roll surface, whereby later marking defects will develop on the web being calendered. Moreover, the rolls may damage beyond repair and at least need more frequent cleaning. As the change of calender rolls needs stopping the entire production line, it is obvious that combining a blade coating process with on-line calendering into a single integrated production line requires precise optimization of the process and equipment, as well as remarkable attention in process control and production management.

In metered film transfer application, the coating is transferred to the surface of a paper web with the help of a roll, whereby onto the roll surface is first metered a layer that after being transferred to the web surface gives the desired coat thickness. While a small amount of coating will inevitably remain on the surface of the film transfer roll, the basic idea is to transfer the metered film as completely as possible to the web surface. The film transfer coating process has been used particularly for surface sizing paperboard webs and application of the first and second coating layers, while it has been a common opinion that in the application of the top layer of a fine paper or other multilayer coated grade it is impossible to attain a sufficiently high finished product quality using the film transfer technique.

Prior-art attempts to use metered film transfer for applying the top coat of a multilayer paper grade have been unsuccessful due to inappropriate process conditions. The functionality of this technique has been hampered by runnability problems and quality defects. However, metered film transfer application can offer benefits in a coating process. For instance, the thickness of the applied coat is highly conformal with the contour of the underlying layer, e.g., the base web contour so that the applied coat layer has the same thickness at the peaks and valleys of the underlying surface, whereby the film transfer technique is capable of applying a so-called contour coat layer. As a result, the film transfer coating method can achieve an extremely good surface smoothness (uniform coat thickness) even at low coat weights. Common belief is although that the film transfer coating technique is not suitable for use in the application of the top layer of fine paper grades due to runnability and quality problems and, resultingly, the top coat layer has been conventionally applied using a blade coater unit.

Also the base sheet typically having qualities optimized for blade coating has caused obstacles in the adoption of film transfer coating. The smoothness of the base web and its surface texture, particularly the porosity thereof, have been incompatible with film transfer coating, thus undermining the possibility of manufacturing a web surface of good printability required from fine paper.

Paper grades made from a base web of higher content of mechanical pulp or recycle fiber are not conventionally categorized as fine papers, but rather as wood-containing grades. Respectively, papers manufactured principally from chemical pulp are called wood-free paper grades. These base paper types are problematic in blade coating under the high stress imposed by the doctor blade on the base web. A web containing a high proportion of mechanical pulp or recycle fiber becomes weaker than a web made from chemical pulp alone due to, among other reasons, the shorter length of fiber in the former type of web as compared with the fiber length of chemical pulp. Hence, blade coating on these paper web types is possible only if the base web is sufficiently thick. As a result, the price of the product becomes high and, notwithstanding the generally more cost-advantageous pricing of mechanical pulp and recycle fiber as compared with chemical pulp, all extra fiber/pulp needed in production increases the final price of the product.

It is an object of the present invention to provide a method for application of a multilayer coating such that all the web treatment layers, particularly the top layer; can be fabricated using a metered film transfer technique.

The goal of the invention is achieved by applying each one of the web treatment layers using metered film transfer application, whereby with the exception of the top layer, the solids content of the web treatment furnish during application in at least one layer is at least 62%, advantageously at least 70%.

Among other techniques, the base paper properties are optimized suitable for metered film transfer by precalendering and, the surface porosity of the base web and each applied web treatment agent layer is arranged maximally optimal for metered film transfer application.

Advantageously, the application of the web treatment agent is performed simultaneously on both sides of the web being treated using a two-sided coater station. More specifically, the method in accordance with the invention is characterized by what is stated in the characterizing part of claim 1.

The invention offers significant benefits.

The invention gives improved process and raw material utilization efficiency. In regard to the drying steps, the successive application and web treatment steps can be carried out optimally by adjusting the solids contents of the furnishes used and the resulting surface porosity such that the moisture content of the applied layer is removed at a maximal rate. The overall dryer capacity needed in the process is also lowered, whereby production costs are reduced and the machine length becomes shorter thus involving smaller investment costs. Particularly in on-line multinip calender sections, the invention offers wide benefits by virtue of the improved system runnability thus allowing the use of an on-line multinip calender even for such paper grades that otherwise could not be run in the installation, e.g., due to the risk of roll damage. Hereby, for instance revamping from two separate calenders into one on-line calender can give substantial yields in investment costs and improved process efficiency. Improved process efficiency is chiefly caused by the lower number of web breaks due to lower stress imposed on the web being treated. Furthermore, reduction of coating defects also lowers the risk of damage to the calender rolls thus increasing the overall profitability of production through higher level of production quality.

One of the essential benefits is the possibility of achieving substantial savings in investment and raw material costs over prior-art process methods. Lower investment costs result from the more compact embodiment of the process and equipment. Reduced raw material costs are achievable through the possibility of increased amount of fillers and thus decreased amount of sulfate pulp. The latter is based thereon that the requirements set on the runtime strength of the web in the process are relaxed as compared to prior-art blade coating methods. In regard to runnability in a coating process, a crucial factor is the wet strength of the web after coating application. To attain a sufficient wet strength, conventional method may need a base web of higher strength than what would be needed in the finished dry product, whereas any approach capable of reducing the required production runtime strength can offer more cost-effective finished products and wider selection of manufactured products. In blade coating, the major reason of web breaks is related to tears or holes in the web that at the blade cause immediate break of the web. In contrast, metered film transfer coating has a minimal risk of web break at a hole in the web.

In support of the above statements a comparison is given in Table 1 between the investment costs of different types of coater lines and the production costs therein. When the achievable savings are added, the method according to the invention appears superior over conventional blade coating in the application of the paper web top coat, whereby the greatest cost saving items are those attained through the changes in the base paper composition. Table 1 below shows a comparison between different methods in the manufacture of a two-sided coated wood-containing paper grade.

TABLE 1

| | | C2S MSP + 2C1S | |
|---|---|---|---|
| | 2C2S MSP | BLADE | 4C1S BLADE |
| Raw material costs | | | |
| chemical pulp | <30% | <40% | <50% |
| mechanical pulp | >70% | >60% | >50% |
| filler | >10% | <10% | <8% |
| coating | 95% | 100% | 105% |
| Investment costs | 85% | 100% | 105% |
| Production efficiency | >80% | 80% | 75% |

In the table above, 2C2S MSP refers to two coater units each equipped with a metering film transfer applicator performing two-side coating, C2S MSP refers to a single metering film transfer applicator performing two-side coating and 2C1C refers to two one-side blade coaters. Abbreviation 4C1S refers to four separate one-side coater stations.

Tables 2 and 3 below show a respective comparison for certain fine paper grades. The abbreviations of coater station layouts are the same as in the above table so that Table 2 represents two-layer application, while Table 3 represents three-layer application.

TABLE 2

| | | C2S MSP + 2C1S | |
|---|---|---|---|
| | 2C2S MSP | BLADE | 4C1S BLADE |
| Raw material costs | | | |
| chemical pulp | ≧70% | ≧70% | ≧70% |
| mechanical pulp | ≦30% | ≦30% | ≦30% |
| filler | >15% | <15% | <15% |
| coating | 95% | 100% | 105% |
| Investment costs | 85% | 100% | 105% |
| Production efficiency | >80% | 80% | 75% |

TABLE 3

| | | C2S MSP + 4C1S |
|---|---|---|
| | 3C2S MSP | BLADE |
| Raw material costs | | |
| chemical pulp | ≧70% | ≧70% |
| mechanical pulp | ≦30% | ≦30% |
| filler | >15% | <15% |
| coating | 95% | 105% |
| Investment costs | 85% | 110% |
| Production efficiency | >80% | 75% |

In the following, the invention will be examined with the help of exemplary embodiments and by making reference to the appended drawings, in which

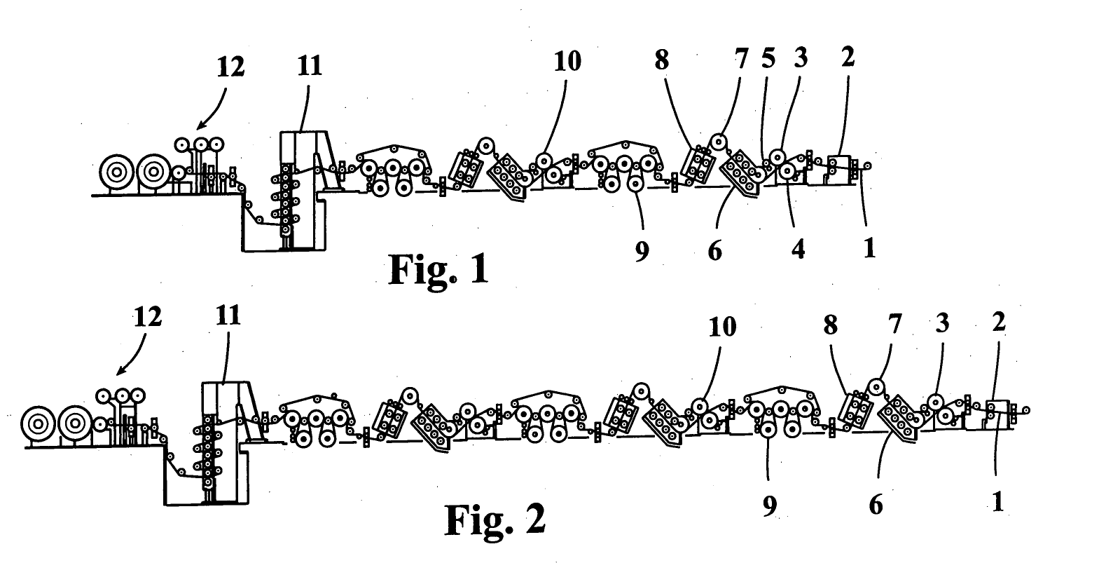

FIG. 1 shows a one embodiment of coater layout according to the invention; and

FIG. 2 shows a second embodiment of coater layout according to the invention.

In the following text, terms coating and coating furnish must be understood to refer to all methods and furnishes in which a pigment material containing mixture is used for treating a web. In addition to these furnishes, the term web treatment agent is used when wider reference is made covering also other compositions, such as surface size, used in web treatment.

Referring to FIG. 1, therein is shown a coater layout for manufacturing two-sided coated paper with two-layer application. While the coater layout can be most advantageously used for setting up an on-line system with a papermaking machine, it is also adaptable to operate as an off-line coater in conjunction with an unwinder. In the layout, the first unit is a precalender 2 in which the web surface is smoothed for later treatment. The precalender may be a machine calender, a soft-nip calender or other calender type capable of producing a suitable web surface smoothness. The aspects to be considered in the selection of a suitable precalender are the required web surface smoothness and machine speed, the latter being a crucial selection criterion particularly in on-line layouts. Precalendering can be effectively used for improving the smoothness of coating layers applied thereafter, whereby it also serves to affect the pore size of the base sheet that strongly contributes to successful coating. The function of base web pore size is described in more detail later in the text. While the term coating is generally used in this text, it must be understood that the first application layer may as well be made using surface size or any other web treatment agent. In accordance with the invention, surface sizing may be followed by two-layer application or three-layer application. When surface size is applied, its solids content must be high, advantageously greater than 10%. Combination of surface sizing with two-layer application means that both sides of the web will receive three treatments with the provision that the same treatments are applied to both sides. From the precalender 2 the web 1 is taken to a first two-side metering film transfer applicator 3. This kind of applicator comprises two applicator rolls 45 forming a nip through which the web 1 is passed. On both of the applicator rolls is adapted a metering device 5 that applies a web treatment agent layer of a predetermined thickness on the outer surfaces of applicator rolls 4. As the web passes between the applicator rolls, the coating layer applied to their outer surfaces is transferred to the surface of web 1, whereby a coating layer of desired thickness is formed thereon. Since the coating layer is transferred as a film from the applicator roll surface onto the web surface, the coat thickness on the web surface becomes equal to that applied to the applicator roll surface, whereby the coat profile becomes exactly the same as the original web surface profile. Hereby, a so-called contour coat layer is attained that gives an optically even surface of extremely high opacifying power. When using metered film transfer application, the surface of applied coating is not leveled by doctoring, because the surface quality provided by the method according to the invention is inherently sufficiently good. In fact, doctoring would undermine the benefits of the contour coating technique and, moreover, the stress imposed on the web would become equal to that encountered in the use of any doctoring technique.

From the first film transfer applicator 3, the web 1 is taken to a first dryer 6. Since now both sides of the web have been treated and thus are wet, the first dryer must be of the noncontact type. The present embodiment uses a dryer type equipped with a drying web-turning device and an air-impingement dryer integrated in a single enclosure. This dryer type provides good drying capacity on the web in relation to the energy consumption of the dryer. In the next phase, the web is passed over a turning roll 7, noncontact dryer 8 and a dryer roll group to a second applicator 10. This second applicator 10 is similar to the first, as also is the next dryer unit downstream thereof As the film transfer applicator used in the method according to the invention can be operated using high-solids web treatment furnishes in conjunction with controlled water migration from furnish to paper, the required drying capacity is reduced and the dryer section becomes shorter. The web need not be dried between the application steps to final upwinder dryness, but instead, it is sufficient to reduce the moisture content of the web so much that a contact with the web surface is possible, whereby the application of the next coating layer can be accomplished.

The last dryer unit is followed by a multinip calender 11. The best calender type for this kind of an on-line layout is an Optiload-type calender equipped with polymer rolls and having independent load control of the roll nips. Also other calender types are possible, but a conventional supercalender for instance does not offer a sufficiently high machine speed without compromising runnability and risk of damage so that the calender could be adapted to operate in conjunction with a fast coater section. It must be borne in mind that a multinip calender is needed in the manufacture of fine paper grades or high-quality wood-containing paper when a premium-quality finished product with a good final quality of web surface is desired. The calender is followed by a winder 12. In lieu of a multinip calender, it is also possible to use, e.g., a soft-nip calender or a soft-nip matte-surface calender. Obviously, the selection of a suitable calender is dictated by the qualities required from the finished product.

FIG. 2 shows a layout suitable for three-layer coating of both sides of a paper web. This layout differs from the embodiment described above only by having three successive coater stations with integrated dryers.

According to this embodiment of the invention, each application step uses a two-side metering film transfer applicator. Each coating layer is applied simultaneously to both sides of the paper web. The method achieves high web speeds, even in excess of 2500 m/s, in both two-layer and three-layer application and, moreover, the two-side coating of the web makes machine layout compact, thus offering substantial savings in machine footprint.

The runnability of the layout according to the invention is crucially affected by the generation of stray coating furnish mist at the point where the web leaves the applicator roll in the nip. Respectively, the properties and quality of the paper grade being manufactured are essentially affected by the mutual proportions of the coating layers being applied above one another and the solids content of the coating furnish to be used therein. These factors must be optimized in order to attain acceptable runnability and good quality of the finished product. If the coat thickness applied to a given coating layer is excessively high, it causes generation of stray mist of the coating furnish and formation of an orange peel texture on the coated surface. Mist generation is not acceptable to avoid contamination of the machine and environment. Furthermore, stray coating furnish mist travels along with the web and adheres to the surface thereof thus forming a dust layer that causes picking during printing. As a result, the printing machine and particularly the printing surfaces thereof are contaminated, whereby the quality of the printed material is impaired. Inasmuch as the goal of multilayer coating is to achieve the best possible quality of the printable surface, these complications are very severe. Orange peel texture also marks the surface of the paper web on which high-quality printing it impossible. However, when the solids content of the coating furnish applied in one or more coating layers is maximized, a high final amount of coating can be retained on the web in a given coating layer even when the applied amount is reduced. To apply a high-solids coating furnish on the surface of an applicator roll, the diameter of the applicator rod in the film transfer application unit of the applicator apparatus must be reduced. The function of the applicator rod is to meter and smooth the layer of coating furnish applied on the surface of the applicator roll. While conventional systems generally use a 25 mm dia. rod, the solids contents employed in the present invention can be metered using a rod diameter of, e.g., 15 mm, 12 mm or even as small as 10 mm.

Moreover, application of the overall coat weight in separate steps of multiple layer applications allows the amount of coating furnish applied in each individual step to be kept reasonably small. Both of the above-mentioned features reduce stray mist generation and formation of orange peel texture. Optimized porosity of the base web and coating layers applied thereon assures rapid dewatering and setting of each applied layer thus permitting the application of thicker layers in succession. This condition is attained by increasing the absorption capability, known as the capillary penetration, of the base web and lowermost coating layers applied thereon. As a result, a faster drying touch-dry surface of the applied coating surface is attained.

The most cost-efficient approach is to optimize the amount of coating furnish applied in the lowermost layers, which means that preferably a maximum amount of low-cost coating formulation can be used in the precoat layers. Then, the top coat layer can be made using a maximally thin layer of a more expensive coating furnish that need be applied only so much that a uniform top coat results on the web surface. With the help of test results, Appendix A elucidates the contribution of solids content and use of multiple coating layers on the quality of the paper grade being manufactured. The first row gives the results of the state-of-the-art manufacturing technology, while two other rows represent the outcome of the present invention. On the basis of the test results it is also obvious that the increased solids content not only eliminated the generation of stray coating mist in the application nip at the coater outgoing side, but also eliminated the formation of coarse surface texture related to cracking of the coating layer film at the outgoing side of the coater and, simultaneously, increased the opacifying power of the coating due to its decreased penetration. A still further increase in the web surface smoothness and essential improvement of the visual uniformity of the surface was obtainable by using three-layer application instead of two layer application.

Metered film transfer coating facilitates application of lower coat weights than those possible in a blade coater, yet keeping the opacifying power at the same level. This is contrary to the common belief that the application of the top coat layer by metered film transfer coating is impossible due to the above-discussed stray mist generation problems and poor surface smoothness of treated web surface occurring in film transfer coating of high coat weights. In the concept according to the invention, the coat weight in the precoat layers has been increased from 6-8g/m² to 8-14g/m² and the solids of the precoat layers from 68% to 73%, whereby it has been possible to reduce the amount of coating furnish needed for the top coat layer, yet keeping the final coat weight unchanged. Hereby the overall cost of coating is lowered due to the reduced amount of top coat material.

The occurrence of stray mist and orange peel patterning, as well as other surface defects, was further investigated in test runs carried out by varying the web speed between 1500 m/min and 3200 m/min. The test runs were performed using both two-layer and three-layer application without detecting generation of stray coating mist after the optimization of the process conditions according to the invention.

Table 4 below shows the process conditions of an exemplary test and Table 5 shows the qualities of the paper manufactured in the test.

TABLE 4

| Parameters | 2C2S MSP | 3C2S MSP |
|---|---|---|
| Basis weight [g/m²] | 90.0 | 90.0 |
| Web speed [m/min] | 1800 | 1800 |
| Leveling rod dia. [mm] | 15/—/15 | 15/15/15 |
| pre/middle/top coat | | |
| Coat weight [g/m²/side] | 10.0/—/8.0 | 4.5/4.5/9.0 |
| pre/middle/top coat | 12.0/—/6.0 | 6.0/6.0/6.0 |
| Solids content [%] | 70.0/—/67.0 | 68.0/67.0/65.0 |
| pre/middle/top coat | 72.0/—/67.0 | 69.0/68.0/65.0 |

TABLE 5

| Parameters | 2C2S MSP | C2S MSP + 2C1S BLADE |
|---|---|---|
| Basis weight [g/m²] | 90.0 | 90.0 |
| Bulk [cm³/g] | 0.80-0.81 | 0.76-0.77 |
| Moisture content [%] | 5.5 | 5.5 |
| PPS-s10 roughness [μm] | 0.98/1.10 | 0.95/0.98 |
| Hunter 75/75 gloss | 74.3/76.1 | 75.1/75.5 |
| Opacity [%] | 92.1 | 91.9 |

As Table 5 shows, the method according to the invention provides equivalent qualities as those achievable by using a blade coater for making the top coat layer.

In a comparative test run, the following preferable solids content values were found suitable at different web speeds for the coating mix used in the precoat of a wood-containing MWC paper grade: 66% to 68% at 2000 m/min, 68% to 70% at 2500 m/min and greater than 70% at 3000 m/min. These solids content values must be considered as preferred lower limit values at the given web speeds. Reduction of stray mist generation was possible by increasing the solids content values of coating furnishes and improving runnability with different furnishes by virtue of, e.g., reducing the tendency of droplet formation at the leveling rod of the applicator apparatus.

Table 6 shows examples of process parameters used in a test run performed using two two-side applicator apparatuses.

TABLE 6

| Parameters | 2C2S MSP |
|---|---|
| Basis weight [g/m²] | 90.0 |
| Web speed [m/min] | 1800 |
| Leveling rod dia. [mm] | 15/—/15 |
| pre/middle/top coat | |
| Coat weight [g/m²/side] | 14-12-10/—/6-8-10 |
| pre/middle/top coat | |
| Solids content [%] | 69-71/—/64-66 |
| pre/middle/top coat | |

The overall coat weight is the same, that is 20 g/m²/side for each coater layout combination.

The coating method according to the invention is based the concept of reducing the average value of the surface pore size distribution stepwise from layer to layer starting from the base sheet and ending at the top coat layer. Additionally, the pore sizes must be adjusted according to the particle size of the solids portion in the coating furnish such that the underlying coating layer is impervious to the solids particles of the overlying layer being applied but yet offers maximally good penetration to water contained in the furnish. This assures a uniform coat application. The pore size must also be adapted optimal for the penetration of water or other liquid contained in the furnish in order to obtain rapid sorption of the liquid to the next underlying layer. The precoat must have good sorption to water in order to assure rapid setting of the top coat or an intermediate coat layer and to avoid generation of stray coating mist. The same precondition is also assumed in the application of the precoat when large amounts of furnish are to be applied. The optimal pore size of the base sheet is such that penetration of solids particles under the surface of the base sheet is prevented, yet maintaining maximally high and rapid sorption of water. This is attained by good retention of base sheet fiber and fillers on the base sheet surface. However, simultaneously is also assured such a pore size distribution that gives rapid setting of the applied coating. The filler content of the base sheet, as well as the amount and proportion of fiber in the base paper, is characterized by the ash content of the paper defined as the amount of noncombustible matter after combustion of a paper sample. For a base paper suitable for use in the invention, the ash content should not be lower than 10%.

The invention makes it possible to improve paper qualities such as opacity and brightness. Opacity is improved inasmuch as chemical pulp can be replaced by mechanical pulp. Increased use of mechanical pulp also seals the surface of the base sheet and improves the opacifying power of the coating, since less coating can penetrate into the pores of the base sheet. Due to the same reason, also paper brightness is improved, because the improved opacifying power reduces brightness deviations thus giving a coating layer of uniform thickness irrespective of profile deviations on the base sheet surface.

An important feature of the present invention is precalendering prior to the first application step. Since the surface profile of a coating layer applied by metered film transfer application follows accurately the surface profile of the base sheet with a coating layer of uniform thickness over both the peaks and valleys of the underlying surface, the applied coating does not smooth the web surface in the same fashion as coating applied by a blade coater that causes the coating to fill the valleys of the base sheet profile under the pressure imposed by the blade. Accordingly, when a smooth coated surface is desired, the base sheet surface must be relatively smooth already prior to starting application. As the surface smoothness of the base sheet is determined, among other factors, by the base sheet manufacturing process and the raw materials used therein, the invention is well suited for use on base sheet grades manufactured using large amounts of fillers. Since the surface smoothness and pore size are also affected by the proportion of fines in the pulp used, the base sheet advantageously should be composed of fine-milled fiber. Hence, the surface smoothness and thus the need for precalendering are dictated by the above-mentioned properties of the base sheet. Nevertheless, precalendering is anyhow necessary for good smoothness even when the base paper inherently has a good surface quality.

As is already evident from the text above, the solids content of the coating is highest in the first coating layer and then is reduced toward the top coat layer. This is due to two reasons. Preferably, the top coat layer is made thin due to the high cost of its furnish material. In the application of a thin coating layer, the problem from stray mist generation is smaller than in the application of the thicker precoat and intermediate coating layers. On the other hand, a reduced solids content improves the flowability of the coating furnish and allows the coating to conform more smoothly with the web surface thus rendering a slightly smoother surface. The precoat and intermediate coating layers can be made using furnish materials that in a coating mix give a lower viscosity and flow resistance than the materials of the top coat furnish.

Hence, these layers can be applied using a higher solids content of the coating furnish without causing generation of stray coating mist on the outgoing side of the application nip and other quality problems.

As a layout used for multilayer application generally comprises a plurality of coater stations, in certain cases it may be preferred to arrange the web to bypass one or more stations. While three-layer application, for instance, needs three coater stations, bypassing one station could allow two-layer application in the same layout thus offering a wider selection of products. Conversely, the stations could be serviced alternately with the rest of them running simultaneously, whereby no service break would shut down all the production capacity of the on-line coater machine. However, bypassing single coater stations is difficult. Conventionally, the tail-threading belts or ropes are located on the service side of the machine inasmuch as there is more space and the machine operator can guide the ropes if necessary. The ropes extend over the entire length of the machine, and tail threading takes place once for the whole machine. Should a disturbance occur at the end of the machine, the only chance to run the machine without stopping it is to dump the web into the broke pulper at a point preceding the cause of the disturbance. However, by providing the machine at its coater stations, for instance, with a second set of tail-threading ropes or belts on its service side and then adapting the ropes/belts to pass via the space below the machine, for instance, the web can be arranged to travel supported by guide rolls under the bypassed coater station and then again threaded into the machine after the bypassed coater station. In an off-line machine it is easy to change tail threading from one side of the machine to the other, because herein it is only necessary to move the tail-threading belt to the other side of the web and then attach the tail-threading belt to the passing-by tail-threading rope. In an on-line machine, however, the tail-threading operation must be carried out at a high speed while the machine is running, whereby the use of a tail-threading belt attachable to the web is impossible. Herein, tail-threading must take place by severing from the edge of the passing-by side of the web a strip that is guided between the tail-threading belts of the service side. An on-line machine is generally equipped with a pair of belts or ropes between which the strip severed from web is pressed. When the strip thus guided returns to the process line of the machine after a coater station, for instance, the web is first allowed to spread into its full width and thereupon a tail-threading strip is severed in a conventional fashion from the service-side edge of the web and then passed downstream by the conventional tail-threading routines. Simultaneously the web is disconnected from the auxiliary tail-threading system and passed into the broke pulper until it is possible to spread the web to its full width.

The above-described assembly and arrangement are suited for bypassing any part of the machine, whereby the bypass operation allows the bypassed machine parts to be set nonfunctional and thus to be serviced. Conversely, it becomes possible to run a wider selection of different products on the machine. An alternative possibility of increasing the system flexibility is to arrange a facility of stopping of the coater station and opening of its application nip such that the web can travel without contacting the applicator rolls and thus pass untreated through the station. Since in this case no web treatment agent is applied in the coater station to the web surface, the respective dryers may also be shut down with the provision that web guidance system allows this facility. Namely, at least in air-impingement dryers it is anyhow necessary to guide the web at least by cold air jets to prevent the web from touching the dryer structures.

1. A method for manufacturing a coated paper grade having at least one side coated with at least two coat layers, the method comprising the steps of
applying a coating furnish layer to at least one surface of said paper web,
drying the coating furnish layer to a point allowing a next coating layer to be applied thereon,
applying a second coating layer on said first coating layer,
drying said second coating layer, and
continuing the application of successive coating layers until the desired coat thickness is attained,
characterized in that
said coating layers are applied using a metering film transfer method operating without leveling of the applied coating layer by doctoring, and
using in at least one of said coating layers a furnish having a solids content of not less than 62%.

2. The method of claim 1, characterized in that the solids content of the web treatment agent used in the application of said first coating layer is not less than 65%.

3. The method of claim 1 or 2, characterized in that the solids content of web treatment agent furnishes applied in said successive coating layers is reduced stepwise toward the top layer of the finished product.

4. The method of claim 1, characterized in that the composition of both the base sheet and the web treatment agents to be applied thereon as separate coating layers is selected such that the pore size in each successive coating layer is smaller than in the underlying layer thereof, whereby the pore size in the underlying layer is adjusted such that the solids particles of the next overlying layer will not penetrate into the underlying layer.

5. The method of claim 1 or 4, characterized in that the base sheet is calendered at least once prior to the application of the first coating layer.

6. The method of any one of foregoing claims, characterized in that the coated paper web is calendered by means of a multinip calender after the application of the last coating layer.

7. The method of any one of foregoing claims 1-5, characterized in that the coated paper web is calendered by means of a soft-nip calender after the application of the last coating layer.

8. The method of claim 1 or 2, characterized in that the coat weight (g/m²) of an underlying coating layer in the dried coat is always higher than the coat weight of the next overlying coating layer.

9. The method of claim 1 or 2, characterized in that the ash content of the base sheet is not smaller than 10%.

10. The method of claim 1, characterized in that, in the first coating layer applied to the surface of the base sheet, the solids content is at least 66% to 68% at a web speed of 2000 m/min, 68% to 70% at a web speed of 2500 m/min and not smaller than 70% at a web speed of 3000 m/min.

11. The method of any one of foregoing claims, characterized in that both sides of the paper web are coated simultaneously in each of said application steps.

12. An assembly for manufacturing a coated paper grade having at least one side coated with at least two coat layers, the assembly comprising
a calender (2),
at least two coater stations (3, 10) for applying at least two coating layers to at least one surface of a base sheet (1), and
means (6, 7, 8, 9) for drying each applied coating layer at least partially prior the next treatment step of the web (1),
characterized in that
said coater stations (3, 10) are premetering two-side film transfer applicators comprising two nip-forming film transfer rolls (4), from the surface of which the coating is transferred simultaneously to both sides of the through-passing base paper web.

13. The assembly of claim 12, characterized in that the number of coater stations is two.

14. The assembly of claim 12, characterized in that the number of coater stations is three.

15. The assembly of any one of claims 12-14, characterized in by a multinip calender (11) adapted to operate in the web travel direction downstream from the last coater station.
